(19) United States
(12) Patent Application Publication
(10) Pub. No.: US 2010/0097344 A1
(43) Pub. Date: Apr. 22, 2010

(54) ELECTRONIC APPARATUS WITH A CAPACITIVE TOUCH SENSOR

(75) Inventor: FRANS VERWEG, H.Freezerstraat (NL)

Correspondence Address: LOWE HAUPTMAN HAM & BERNER, LLP, 1700 DIAGONAL ROAD, SUITE 300, ALEXANDRIA, VA, 22314, US

(73) Assignee: TPO DISPLAYS CORP., Chunan (TW)

(21) Appl. No.: 12/434,341

(22) Filed: May 1, 2009

Related U.S. Application Data
(60) Provisional application No. 61/105,994, filed on Oct. 16, 2008.

(51) Int. Cl. G06F 3/045

(52) U.S. Cl. 345/174

(57) ABSTRACT

A capacitive touch sensor for use with a display device is described. The capacitive touch sensor includes a first sensor electrode layer including a first electrode, a second sensor electrode layer including a second electrode, and a sensor dielectric layer including a polarizer, the sensor dielectric layer arranged in between the first sensor electrode layer and the second sensor electrode layer. The first electrode can have a plurality of first sensor elements. The second sensor electrode layer can act as a shielding electrode. An apparatus including a display module including a capacitive touch sensor and a display device is described. The first sensor electrode layer is applied on a transparent window plate in the cover of the apparatus.

### CROSS REFERENCE TO RELATED APPLICATIONS

This application claims the right of priority based on U.S. Provisional Patent Application No. 61/105,994 entitled “Mobile Display Module with Window with Integrated Capacitive Touch”, filed on Oct. 16, 2008, which is incorporated herein by reference and assigned to the assignee herein.

### FIELD OF INVENTION

The invention relates to a capacitive touch panel for use with a display device. Another aspect of the invention relates to a display module comprising a capacitive touch panel. Another aspect of the invention relates to a method of manufacturing a display module comprising a capacitive touch panel. Another aspect of the invention relates to an apparatus comprising such display module.

### BACKGROUND OF THE INVENTION

Touch panels are widely used to allow user interaction with electronic devices. In particular, a transparent touch panel can be used on top of a display device to allow a user to interact with the display device, e.g. to respond to a query shown as a pop-up on the display device by touching the displayed query, to select an item from a menu shown on the display device by touching a selected item, to scroll through a list of items, or even to provide a free-format input, e.g. draw an object on the display device, such as hand-written characters for inputting text. Touch panels are e.g. used in mobile phones, portable media players, gaming devices and other portable consumer appliances, as well as with e.g. computer displays.

A known capacitive touch sensor for use with a display device comprises a glass plate provided with a first electrode comprising a plurality of first sensor elements on one face of the glass plate and a second electrode on the opposite face of the glass plate. When the known capacitive touch sensor and the display device are combined into a display module, the first electrode is facing the user and the second electrode is facing the display device. The first electrode and the second electrode are composed of one or more transparent conductive materials, e.g. ITO or a thin metal layer, such as a thin gold layer. In an example of the known touch panel, the second electrode acts as a shielding electrode, to electrically and magnetically shield the capacitive touch sensor from the display device during use.

In some known display modules, the display device is a liquid crystal (LCD) display device; in some other known display modules, the display device is an organic light emitting diode (OLED) display device. Such construction of such a known display module with a known capacitive touch sensor may have a drawback that the capacitive touch sensor adds a considerable thickness to the thickness of the display device. Such construction may have a drawback that the capacitive touch sensor causes a deterioration of the display quality as seen by the user, e.g. due to the presence of the glass plate in between the display device and the user.

### SUMMARY OF THE INVENTION

It is an aim of the invention to provide an improved capacitive touch panel for use with a display device. It is a further aim of further embodiments of the invention to provide an improved display module including a capacitive touch panel and a display device.

In one embodiment, an electronic apparatus has a display device and a capacitive touch sensor allowing a user to view images shown on the display device through the capacitive touch sensor. The capacitive touch sensor includes a first sensor electrode layer comprising a first electrode, a second sensor electrode layer comprising a second electrode, and a sensor dielectric layer arranged in between the first sensor electrode layer and the second sensor electrode layer. Particularly, there is no glass plate arranged between the first sensor electrode layer and the second sensor electrode layer, so that the thickness of the sensor could be reduced.

In another embodiment, an electronic apparatus has a display device and a capacitive touch sensor allowing a user to view images shown on the display device through the capacitive touch sensor. The capacitive touch sensor includes a first sensor electrode layer comprising a first electrode, a second sensor electrode layer comprising a second electrode, and a polarizer layer arranged in between the first sensor electrode layer and the second sensor electrode layer. Optionally, the polarizer layer is circularly polarized.

In yet another embodiment, an electronic apparatus has a display device and a capacitive touch sensor allowing a user to view images shown on the display device through the capacitive touch sensor. The capacitive touch sensor includes a first sensor electrode layer comprising a first electrode, a second sensor electrode layer comprising a second electrode, and a optically clear adhesive layer arranged in between the first sensor electrode layer and the second sensor electrode layer.

The foregoing and other features of the invention will be apparent from the following more particular description of embodiments of the invention.

### BRIEF DESCRIPTION OF THE DRAWINGS

The present invention is illustrated by way of example and not intended to be limited by the figures of the accompanying drawing, in which like notations indicate similar elements.

FIG. 1a and FIG. 1b schematically show an apparatus having a capacitive touch screen on top of a display device;

FIG. 2a and FIG. 2b schematically show a capacitive touch sensor and a display device in an apparatus according to the prior art;

FIG. 3a, FIG. 3b and FIG. 3c schematically show alternative configurations of a capacitive touch sensor and a display device in an apparatus according a first aspect to the invention;

FIG. 4 schematically shows a capacitive touch sensor and a display device in an apparatus according to a second aspect of the invention; and

FIG. 5a-FIG. 5d schematically show alternative arrangements of the layers of the capacitive touch sensor.

### DETAILED DESCRIPTION

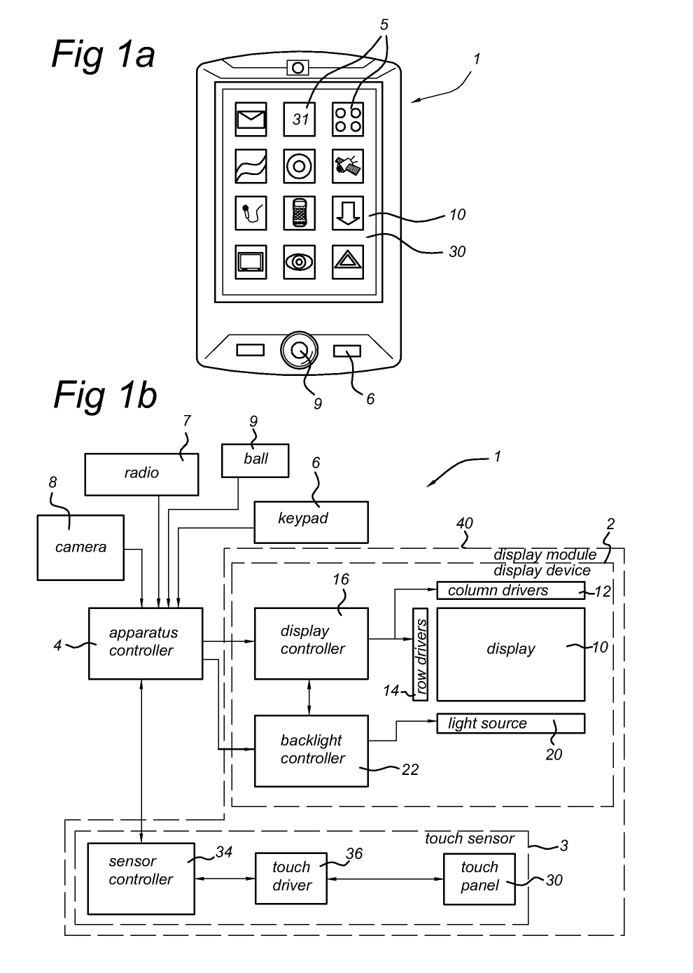

FIGS. 1a and 1b schematically show an apparatus 1 according to the invention. The apparatus 1 comprises a display device 2, a capacitive touch sensor 3, and an apparatus controller 4 arranged to operate the capacitive touch sensor 3 and to operate the display device 2. The arrangement of display device 2 and capacitive touch sensor 3 may be referred to as a display module 40.

The apparatus 1 may further comprise e.g., a keypad 6 arranged for accepting user input for controlling the apparatus 1, a radio 7 arranged for sending and receiving messages such as voice messages, text messages and/or images, and a camera 8 arranged for taking images, and a scroll ball 9 for accepting further user input for controlling the apparatus 1.

The apparatus 1 may e.g. be a mobile phone, as shown in FIG. 1a, a digital still-picture camera, a car navigation system, a mobile DVD-player, a gaming device, or another hand-held consumer appliance, a television, a computer monitor, another large-screen consumer electronics device, or a professional appliance.

The display device 2 comprises a display 10 comprising a plurality of pixels arranged to be driven with pixel drive values, and a display controller 16 arranged to receive color input values of input image pixels of an input image and to drive the display 10 with pixel drive values. The display controller 16 is in electrical communication with column drivers 12 and row drivers 14, for driving the plurality of pixels of the display 10 with the pixel drive values according to known methods. The display controller 16 may be arranged to receive an input image from the apparatus controller 4 and use said input image to drive the display 10. The input image may alternatively be generated, as a whole or part of it, by the display controller 16, e.g. for providing test images. The input image may e.g. represent a menu, which may e.g. be displayed on the display using a set of icons 5.

In the example shown, the display device further comprises a light source 20 and a backlight controller 22. The backlight controller 22 is in electrical communication with the display controller 16 and/or the apparatus controller 4, and with the light source 20. The light source 20 is arranged to illuminate the display 10 when driven by the backlight controller 22. In this example, the display 10 is an LCD display. It is appreciated that an alternative display 10 may be an OLED display, in which case the light source 20 and backlight controller 22 are omitted.

The capacitive touch sensor 3 comprises a transparent touch panel 30, a sensor controller 34 and a touch driver 36. The sensor controller 34 is in electrical communication with the touch driver 36 connected to the electrodes (not shown) on the touch panel 30, for operating the touch panel 30 according to known methods. The sensor controller 34 may in particular be arranged to detect a position on the touch panel 30 of a touch input to the touch panel 30. In alternative embodiments, the sensor controller 34 may just be arranged to detect whether the touch panel 30 is touched or not.

The display 10 is positioned behind the touch panel 30, allowing a user to see the display 10 through the touch panel 30. When the display 10 shows a menu with icons 5, the user can thus see the icons 5 and touch a selected icon using his finger or e.g. a stylus for selecting the icon. When the icon 5 represents an application, the processing application may be launched when the icon is selected and the user may use his finger, or the stylus, to input information to the touch panel 30, thus composing an image associated with the information which is displayed on the display 10. The application may e.g., comprise a text processing application. The text processing application may comprise character recognition for transforming inputted handwritten characters to formatted text. The formatted text may then be displayed on the display. The application may e.g. comprise a drawing application. The drawing application may comprise acquiring inputted drawing elements, such as lines, and showing the drawing elements on the display. It will be appreciated that alternative modes of operating the touch panel 30 and alternative modes of cooperation between the display device 2 and the touch sensor 3 may be used in addition or in stead of the described modes.

It will be appreciated that the blocks shown in FIG. 1b may be implemented as individual hardware units, but that various blocks may alternatively be integrated into a single hardware unit. E.g., the display controller 16 and the sensor controller 34 may be integrated in a combined controller unit.

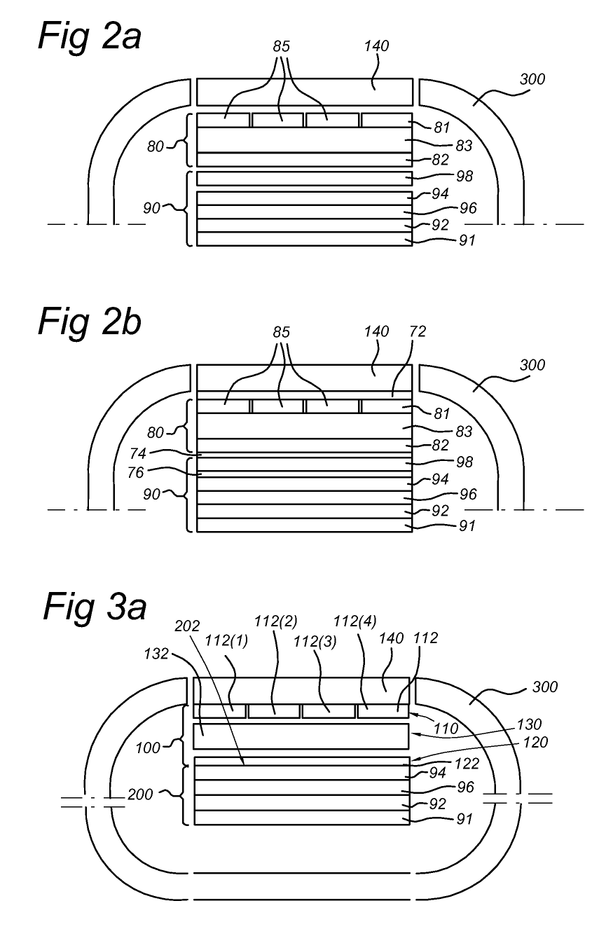

FIG. 2a schematically shows a prior art configuration of a capacitive touch sensor 80 and a display device 90 in an apparatus 1.

The apparatus 1 comprises a housing 300 having a transparent window plate 140 covering the capacitive touch sensor 80 for protecting the capacitive touch sensor 80 and for allowing a user to view images shown on the display device 90 through the transparent window plate 140 and the capacitive touch sensor 80. The capacitive touch sensor 80 comprises a transparent glass plate 83. A first electrode 81 comprising a plurality of first sensor elements 85 is provided on the glass plate 83 at a front side of the capacitive touch sensor 80, i.e. at the side facing the transparent window plate 140. A second electrode 82 is provided as a single electrode on the glass plate 83 at a back side of the capacitive touch sensor 80, i.e. at the side facing the display device 90.

The first electrode 81 and the second electrode 82 are composed of a transparent conductive material, e.g. ITO. The plurality of first sensor elements 85 and the second electrode 83 are connected via the touch driver 36 to the sensor controller 34, as shown in FIG. 1b. The sensor controller 34 is arranged to determine a position on the capacitive touch sensor of a touch input provided by a user to the transparent window plate 140, coupling to the capacitive touch sensor 80, from the plurality of first sensor elements 85 of the first electrode 81 and the second electrode 82 using e.g. known methods. The second electrode 82 acts as a shielding between the capacitive touch sensor 80 and the display device 90, and aims to prevent disturbances in the capacitive touch sensor 80 caused by operating the display device 90 or other components in the apparatus 1.

The display device 90 is a known LCD-type display comprising, in this example, a back plate 92 comprising an active matrix of pixels, a front plate 94, a polarizer 98, an LCD layer 96 sandwiched between the back plate 92 and front plate 94, and a backlight system 91. The polarizer 98 is provided at a front side of the display device 90. The backlight system 91 delivers polarized light to the back plate 92. The backlight 91 system may e.g. comprise a wave guide parallel to the back plate, a light source arranged at a side of the wave guide for emitting light into the waveguide, and an input polarizer between the wave guide and the back plate 92 for delivering polarized light to the back plate 92.

The arrangement of the capacitive touch sensor 80 with the display device 90 may be referred to as a display module. The known display module of FIG. 2a thus comprises a plurality of relatively thick optically transparent layers: the transparent window plate 140, the glass plate 83 of the capacitive touch sensor 80, the polarizer 98, the front plate 94 and the back plate 92. Each of these optically transparent layers may adversely affect an optical quality of the image being viewed through them by a user, especially at the interfaces between two layers.

In FIG. 2a, the transparent window plate 140, the capacitive touch sensor 80 and the display device 90 are shown with a first small spacing in between the transparent window plate 140 and the capacitive touch sensor 80 and a second small spacing in between the capacitive touch sensor 80 and the display device 90. These spacings are drawn to indicate that the transparent window plate 140, the capacitive touch sensor 80 and the display device 90 need not be laminated together, but may e.g. be clamped together to be in close contact or with a marginal spacing only.

FIG. 2b schematically shows a similar prior art configuration of a capacitive touch sensor 80 and a display device 90 in an apparatus 1. In comparison with the prior art configuration of FIG. 2a, the similar prior art configuration comprises a first optically clear adhesive layer 72 in between the transparent window plate 140 and the capacitive touch sensor 80 instead of the first small spacing of FIG. 2a. The first optically clear adhesive layer 72 provides mechanical and optical contact between the transparent window plate 140 and the capacitive touch sensor 80. The similar prior art configuration further comprises a second optically clear adhesive layer 74 in between the capacitive touch sensor 80 and the display device 90 instead of the second small spacing of FIG. 2a. The second optically clear adhesive layer 74 provides mechanical and optical contact between capacitive touch sensor 80 and the display device 90. FIG. 2b further shows that the polarizer 98 may be laminated with a third optically clear adhesive layer 76 to the front plate 94 of the LCD-type display.

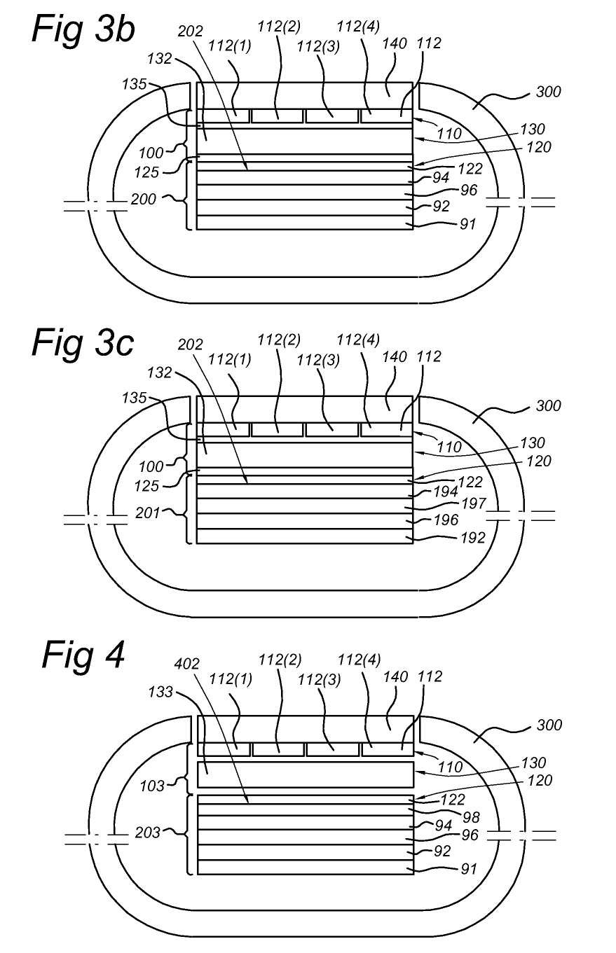

FIG. 3a schematically shows a new configuration of a capacitive touch sensor 100 and a display device 200 in an apparatus 1 according to a first aspect of the invention.

The apparatus 1 comprises a housing 300 having a transparent window plate 140 covering the capacitive touch sensor 100 for protecting the capacitive touch sensor 100. The capacitive touch sensor 100 comprises a polarizer 132 forming a sensor dielectric layer 130. A first electrode 112 comprising a plurality of first sensor elements 112(1)-112(2) is provided on the transparent window plate 140 in a first sensor electrode layer 110 at a back side of the transparent window plate 140. A second electrode 122 is provided as a single electrode in a second sensor electrode layer 120 on a front surface 202 of the display device 200, and more specifically, in this example, on a front surface 202 of the front plate 94 of the display device 200.

The first electrode 112 and the second electrode 122 are composed of a transparent conductive material, e.g. ITO. In alternative embodiments, the first electrode 112 and the second electrode 122 comprise a thin metal layer, e.g. Au, or an transparent conductive organic layer. The plurality of first sensor elements 112(1)-112(4) and the second electrode 122 are connected via the touch driver 36 to the sensor controller 34. The sensor controller 34 is arranged to determine a position of a touch input to the transparent window plate 140, coupling to the capacitive touch sensor 100, from the plurality of first sensor elements 112(1)-112(4) of the first electrode 112 and the second electrode 122 using e.g. known methods.

The sensor controller 34 may be arranged to provide the first electrode 112 with a sensor voltage waveform for charging and/or discharging the first electrode 112, provide the second electrode 122 with the sensor voltage waveform for charging and/or discharging the second electrode 122, detect a charging and/or discharging behavior of the first electrode 112 upon providing the first electrode 112 with the sensor voltage waveform, detect a corresponding charging and/or discharging behavior of the second electrode 122 upon providing the second electrode 122 with the sensor voltage waveform, and determine a touch input characteristic associated with the touch input from a comparison of the charging and/or discharging behavior of the first electrode 112 and the charging and/or discharging behavior of the second electrode 122. The sensor controller 34 may be arranged to determine a position of the touch input to the capacitive touch sensor 100 from the touch input characteristic. The sensor controller 34 may be arranged to detect a charging and/or discharging behavior of each of at least two first sensor elements 112(1)-112(4) upon providing the first electrode 112 with the sensor voltage waveform, and determine the position of the touch input to the capacitive touch sensor 100 from the touch input characteristic associated with the touch input from a comparison of the charging and/or discharging behavior of the at least two first sensor elements 112(1)-112(4) of the first electrode 112 and the charging and/or discharging behavior of the second electrode 122.

The second electrode 122 acts as a shielding between the capacitive touch sensor 100 and the display device 200, and aims to prevent disturbances in the capacitive touch sensor 100 caused by operating the display device 200.

The display device 200 is a LCD-type display comprising, in this example, a back plate 92 comprising an active matrix of pixels, a front plate 94, an LCD layer 96 sandwiched between the back plate 92 and front plate 94, and a backlight system 91. The backlight system 91 delivers polarized light to the back plate 92. The backlight 91 system may e.g. comprise a wave guide parallel to the back plate, a light source arranged at a side of the wave guide for emitting light into the waveguide, and an input polarizer between the wave guide and the back plate 92 for delivering polarized light to the back plate 92. In comparison with the display device shown in FIG. 2a, the display device 200 lacks the polarizer 98; the function of the polarizer 98 is now performed by the sensor dielectric layer 13 in the capacitive touch sensor 100.

The new display module of FIG. 3a thus comprises less relatively thick optically transparent layers compared to the known display module of FIG. 2a. In particular, the display module of FIG. 3a lacks the glass plate between the first sensor electrode layer 110 and the sensor dielectric layer 130. As a result, the new display module of FIG. 3a may be thinner than the known display module of FIG. 2a, and the new display module of FIG. 3a may be have an improved image quality compared to the known display module of FIG. 2a.

It will be appreciated that the first sensor electrode layer 110 and the sensor dielectric layer 130 may be in direct contact, or alternatively be separated at a small distance as shown in FIG. 3a. It will be appreciated that the sensor dielectric layer 130 and the second sensor electrode layer 120 may be in direct contact, or alternatively e.g. be separated at a small distance as shown in FIG. 3a.

FIG. 3b schematically shows a new configuration of a capacitive touch sensor 100 and a display device 200 in an apparatus 1 according to the invention.

The configuration of FIG. 3b is similar to that of FIG. 3a, but in addition comprises a first optically transparent adhesive layer 135 between the transparent window plate 140 with the first sensor electrode layer 110 and the polarizer 130. The first optically transparent adhesive layer 135 may fully laminate the polarizer 130 to the transparent window plate 140 with the first sensor electrode layer 110.

The configuration of FIG. 3b further comprises a second optically transparent adhesive layer 125 between the polarizer 130 and the second sensor electrode layer 120.

It will be appreciated that the display device may be replaced by an OLED-type display device 201 as shown in FIG. 3c.

FIG. 3c schematically shows a new configuration of a capacitive touch sensor 100 and an OLED-type display device 201 in an apparatus 1 according to a first aspect of the invention.

The capacitive touch sensor 100 in FIG. 3c is configured in a similar way as shown in FIG. 3b and described with reference to FIG. 3b, and is hence not described again here.

The OLED-type display device 201 comprises a back plate 192 comprising an active matrix of pixels, a front plate 194, a layer of organic light-emitting material 196 sandwiched between the back plate 192 and the front plate 194, and an optically transparent electrode layer 197 sandwiched between the layer of organic light-emitting material 196 and the front plate 194. The optically transparent electrode layer 197 is arranged to emit light when the active matrix of the back plate 192 drives a current through the layer of organic light-emitting material, the current being driven between the back plate 192 and the electrode layer 197.

Compared to the above described LCD-type display device 200, the OLED-type display device 201 lacks the backlight system 91, and the LCD layer 96 is replaced by the layer of organic light-emitting material 197 and the optically transparent electrode layer 197.

The polarizer 132 may be a circular polarizer. The circular polarizer may reduce a reflection of ambient light falling into the OLED-type display device 201 and being reflected by the OLED-type display device 201, in particular by the back plate 192.

FIG. 4 schematically shows a capacitive touch sensor 103 and a display device 203 in an apparatus according to a second aspect of the invention.

The apparatus 1 comprises a housing 300 having a transparent window plate 140 covering the capacitive touch sensor 103 for protecting the capacitive touch sensor 103. The capacitive touch sensor 103 comprises an optically clear adhesive (OCA) 133 forming a sensor dielectric layer 130. A first electrode 112 comprising a plurality of first sensor elements 112(1)-112(2) is provided on the transparent window plate 140 in a first sensor electrode layer 110 at a back side of the transparent window plate 140. A second electrode 122 is provided as a single electrode in a second sensor electrode layer 120 on a front surface 402 of the display device 203.

The first electrode 112 and the second electrode 122 are composed of a transparent conductive material, e.g., ITO. In alternative embodiments, the first electrode 112 and the second electrode 122 comprise a thin metal layer, e.g., Au, or an transparent conductive organic layer. The plurality of first sensor elements 112(1)-112(4) and the second electrode 122 are connected via the touch driver 36 to the sensor controller 34. The sensor controller 34 is arranged to determine a position of a touch input to the transparent window plate 140, coupling to the capacitive touch sensor 103, from the plurality of first sensor elements 112(1)-112(4) of the first electrode 112 and the second electrode 122 using e.g., known methods.

The display device 203 is an LCD-type display comprising, in this example, a back plate 92 comprising an active matrix of pixels, a front plate 94, a polarizer 98, an LCD layer 96 sandwiched between the back plate 92 and front plate 94, and a backlight system 91. The polarizer 98 is provided at a front side of the display device 203 and provides the front surface 402 of the display device 203. The backlight system 91 delivers polarized light to the back plate 92. The backlight 91 system may e.g. comprise a wave guide parallel to the back plate, a light source arranged at a side of the wave guide for emitting light into the waveguide, and an input polarizer between the wave guide and the back plate 92 for delivering polarized light to the back plate 92.

It will be appreciated that in alternative embodiments, the display device 203 may be replaced with an OLED-type display device, with a polarizer 98 is provided at a front side of the display device 203 and the polarizer 98 providing the front surface 402 of the display device 203.

The optically clear adhesive (OCA) 133 thus fixates the display device 203 to the transparent window plate 140. As the first sensor electrode layer 110 is provided at the back side of the transparent window plate 140 and the second sensor electrode layer 120 is provided on the front surface 402 of the display device 203, there is no need for applying an intermediate glass plate 83 as was present in the prior art example shown in FIG. 2b. The display module of FIG. 4 thus lacks the glass plate 83 of FIG. 2b. As a result, the new display module of FIG. 4 may be thinner than the known display module of FIG. 2b, and the new display module of FIG. 4 may be have an improved image quality compared to the known display module of FIG. 2b.

In embodiments according to the second aspect, the second electrode 122 is composed of a material which, for its application to the polarizer 98, is compatible with processing steps associated with this application. In an embodiment, the polarizer 98 is a plastic material and the second electrode 122 comprise an ITO layer, which is deposited on the polarizer 98 using a low-temperature ITO-deposition process. In an embodiment, the polarizer 98 is a plastic material and the second electrode 122 comprise a thin metal layer, e.g. Au, which is deposited on the polarizer 98 using e.g. a low-temperature process. In an embodiment, the polarizer 98 is a plastic material and the second electrode 122 comprise a transparent conductive organic layer, which is deposited on the polarizer 98 using e.g. a spincoating process.

In FIG. 4, small spacings are shown in between the optically clear adhesive (OCA) 133 and the first sensor electrode layer 110 and in between the optically clear adhesive (OCA) 133 and the second sensor electrode layer 120. When the optically clear adhesive (OCA) 133 is adhesive on both faces, it will be appreciated that these spacings are only drawn to clearly indicate that the first and second electrode layers 110, 120 are not provided on the optically clear adhesive (OCA) 133 itself.

The optically clear adhesive 133 may be specifically designed for application in the capacitive touch sensor 103 with the display device 203 according to the invention. The optically clear adhesive 133 may be a commercially available product, such as e.g. the 3M™ Optically Clear Laminating Adhesives 8141, 8171, 8173 and 8185, provided by 3M Electronics as adhesives for bonding smooth transparent surfaces, the 3M™ Optically Clear Laminating Adhesives 8142 and 8187, provided by 3M Electronics as an adhesive for bonding smooth or textured transparent surfaces, or the 3M™ Contrast Enhancement Film 8195L5, which is provided by 3M as a highly-transparent contrast enhancement film with a high adhesive strength at front and back side of the film. These films may be laminated using e.g. a nip roll or roller platen press type laminator. These films may e.g. be applied using a strong application pressure and moderate heat, causing the adhesive to develop intimate contact with the bonding surface.

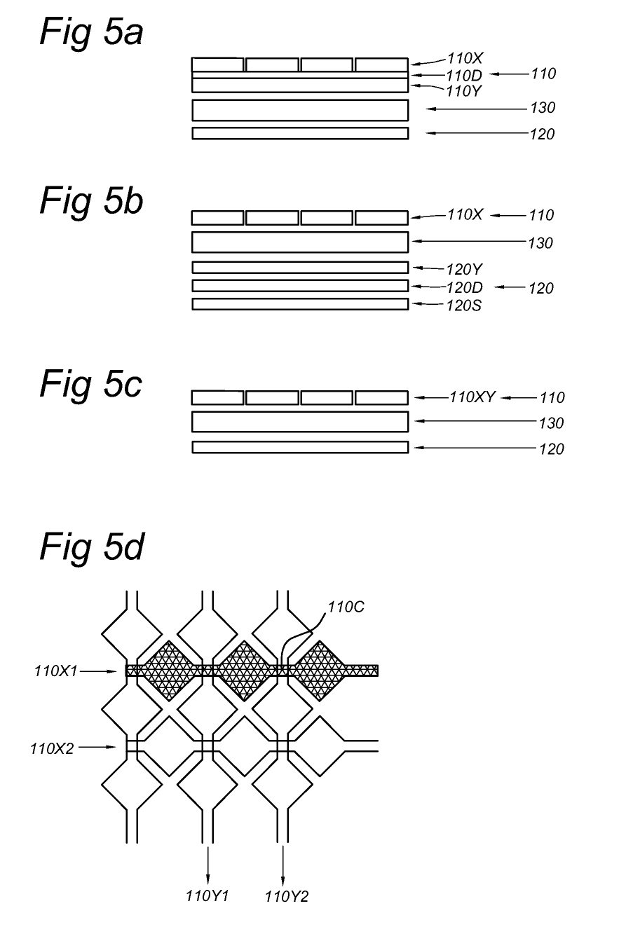

FIG. 5a shows an alternative arrangement of the capacitive touch sensor. In FIG. 5a, the first sensor electrode layer 110 is formed of three stacked layers: layer 110X comprising a first plurality of sensor elements arranged as rows, layer 110Y comprising a second plurality of sensor elements arranged as columns, i.e. substantially transversally to the rows, and dielectric layer 110D positioned in between layer 110X and layer 110Y for electrically isolating layer 110X and 110Y from each other. A position of a touch input may thus be determined along a first direction from the first plurality of sensor elements in layer 110X and along a second direction from the second plurality of sensor elements in layer 110Y. The second electrode 122 provided as a second sensor electrode layer 120 serves to shield the capacitive touch sensor 100 from the display device 200 (not shown in FIG. 5a; positioned beneath second sensor electrode layer 120).

FIG. 5b shows an alternative arrangement of the capacitive touch sensor. In FIG. 5b, the first sensor electrode layer 110 comprises a single layer 110X comprising a first plurality of sensor elements arranged as rows. The second electrode layer 120 is formed of three stacked layers: layer 120S serving to shield the capacitive touch sensor 100 from the display device 200, layer 120Y comprising a second plurality of sensor elements arranged as columns, i.e. substantially transversally to the rows in layer 110X, and a dielectric layer 120D positioned in between layer 120Y and layer 120S for electrically isolating layer 120Y and 120S from each other. A position of a touch input may thus be determined along a first direction from the first plurality of sensor elements in layer 110X and along a second direction from the second plurality of sensor elements in layer 120Y.

FIG. 5c shows an alternative arrangement of the capacitive touch sensor. In FIG. 5c, the first sensor electrode layer 110 comprises a single layer 110XY comprising a first plurality of sensor elements arranged as rows and a second plurality of sensor elements arranged as columns. The first plurality of sensor elements may thus be arranged side-by-side in a two-dimensional matrix. The rows and columns may e.g. be shaped as strings of connected diamonds 110X1, 110X2, 110Y1 and 110Y2 as shown in FIG. 5d. The rows and columns cross using bridges at positions 110C.

While this invention has been described with reference to the illustrative embodiments, these descriptions should not be construed in a limiting sense. Various modifications of the illustrative embodiment, as well as other embodiments of the invention, will be apparent upon reference to these descriptions. It is therefore contemplated that the appended claims will cover any such modifications or embodiments as falling within the true scope of the invention and its legal equivalents.

1. An electronic apparatus, comprising a display device, an apparatus controller for operating said display device, and a capacitive touch sensor, wherein said capacitive touch sensor comprises:
a first sensor electrode layer comprising a first electrode;
a second sensor electrode layer comprising a second electrode; and
a sensor dielectric layer, arranged in between the first sensor electrode layer and the second sensor electrode layer.

2. An electronic apparatus according to claim 1, wherein said sensor dielectric layer comprises an optically clear adhesive.

3. An electronic apparatus according to claim 1, wherein said sensor dielectric layer comprises a polarizer.

4. An electronic apparatus according to claim 3, wherein said polarizer is circular polarizer.

5. An electronic apparatus according to claim 1, further comprising a transparent window plate to cover said capacitive touch sensor; wherein the first sensor electrode layer is arranged between the transparent window plate and the sensor dielectric layer.

6. An electronic apparatus according to claim 1, wherein said second sensor electrode layer faces a front surface of said display device, and said first sensor electrode layer and said sensor dielectric layer are in direct contact.

7. An electronic apparatus according to claim 1, wherein said second sensor electrode layer faces a front surface of said display device, and said second sensor electrode layer and said sensor dielectric layer are in direct contact.

8. An electronic apparatus according to claim 1, wherein said electronic apparatus is a digital still-picture camera, a car navigation system, a mobile DVD-player, a gaming device, or a hand-held consumer appliance, a television, a computer monitor, a large-screen consumer electronics device, or a professional appliance.

9. An electronic apparatus, comprising a display device, an apparatus controller for operating said display device, and a capacitive touch sensor allowing a user to view images shown on said display device through said capacitive touch sensor, said capacitive touch sensor comprising:
a first sensor electrode layer comprising a first electrode;
a second sensor electrode layer comprising a second electrode, and
a polarizer layer, arranged in between the said sensor electrode layer and said second sensor electrode layer.

10. An electronic apparatus according to claim 9, wherein said polarizer layer is circularly polarized.

11. An electronic apparatus according to claim 9, wherein said capacitive touch sensor further comprises: an optically clear adhesive arranged in between said polarizer layer and said second sensor electrode layer.

12. An electronic apparatus according to claim 9, further comprising a transparent window plate to cover said capacitive touch sensor, wherein the first sensor electrode layer is arranged between the transparent window plate and the sensor dielectric layer.

13. An electronic apparatus according to claim 9, wherein said second sensor electrode layer faces a front surface of said display device, and said first sensor electrode layer and said sensor dielectric layer are in direct contact.

14. An electronic apparatus according to claim 9, wherein said second sensor electrode layer faces a front surface of said display device, and said second sensor electrode layer and said sensor dielectric layer are in direct contact.

15. An electronic apparatus according to claim 9, wherein said electronic apparatus is a digital still-picture camera, a car navigation system, a mobile DVD-player, a gaming device, or a hand-held consumer appliance, a television, a computer monitor, a large-screen consumer electronics device, or a professional appliance.

16. An electronic apparatus, comprising a display device, an apparatus controller for operating said display device, and a capacitive touch sensor allowing a user to view images shown on said display device through said capacitive touch sensor, said capacitive touch sensor comprising:
a first sensor electrode layer comprising a first electrode;
a second sensor electrode layer comprising a second electrode, and
an optically clear adhesive layer, arranged in between the first sensor electrode layer and the second sensor electrode layer.

17. An electronic apparatus according to claim 16, wherein said polarizer is circular polarizer.

18. An electronic apparatus according to claim 16, wherein said second sensor electrode layer faces a front surface of said display device, and said first sensor electrode layer and said sensor dielectric layer are in direct contact.

19. An electronic apparatus according to claim 16, wherein said second sensor electrode layer faces a front surface of said display device, and said second sensor electrode layer and said sensor dielectric layer are in direct contact.

20. An electronic apparatus according to claim 16, wherein said electronic apparatus is a digital still-picture camera, a car navigation system, a mobile DVD-player, a gaming device, or a hand-held consumer appliance, a television, a computer monitor, a large-screen consumer electronics device, or a professional appliance.
